(19) United States
(12) Patent Application Publication
(10) Pub. No.: US 2019/0389327 A1
(43) Pub. Date: Dec. 26, 2019

(54) CHARGING CONTROL APPARATUS, CHARGING CONTROL METHOD, AND STORAGE MEDIUM

(71) Applicant: HONDA MOTOR CO., LTD., TOKYO (JP)

(72) Inventor: Tsuyoshi MATSUDA, WAKO-SHI (JP)

(21) Appl. No.: 16/447,203

(22) Filed: Jun. 20, 2019

(30) Foreign Application Priority Data
Jun. 22, 2018 (JP) 2018-118400

(51) Int. Cl. B60L 53/66; B60L 58/13; B60L 53/68; H02J 7/00

(52) U.S. Cl. CPC B60L 53/66; H02J 7/007; B60L 53/68; B60L 58/13

(57) ABSTRACT

A charging control apparatus includes a charging control section that, when an amount of power needed for a vehicle to reach a first charging stand that is selected based on business hours and distance from the location of the vehicle is not held in a battery, performs a first charging to cause the battery to hold the amount of power needed for the vehicle to reach the first charging stand, and the charging control section performs the first charging such that the amount of power held in the battery does not exceed the power needed for the vehicle to reach the first charging stand by an amount greater than or equal to a predetermined value.

### CROSS-REFERENCE TO RELATED APPLICATION

This application is based upon and claims the benefit of priority from Japanese Patent Application No. 2018-118400 filed on Jun. 22, 2018, the contents of which are incorporated herein by reference.

### BACKGROUND OF THE INVENTION

### Field of the Invention

The present invention relates to a charging control apparatus, a charging control method and a program.

### Description of the Related Art

A battery charging apparatus has been proposed that performs timed charging based on a charging start timing and a charging end timing set by a user (Japanese Laid-Open Patent Publication No. 2009-152136). If the charging start timing and the charging end timing are set such that charging is performed during a time when the electricity cost is low, it is possible to save on electricity costs.

### SUMMARY OF THE INVENTION

However, if the remaining battery life is insufficient when it becomes necessary to use a vehicle in an emergency, it is not possible to use the vehicle. On the other hand, in a case where the battery is simply charged to full in order to avoid the occurrence of insufficient remaining battery life, degradation of the battery occurs.

It is an objective of the present invention to provide a charging control apparatus, a charging control method, and a program that make it possible to ensure that an amount of power necessary for emergencies is held in a battery.

The charging control apparatus according to one aspect of the present invention is a charging control apparatus that performs predetermined charging of a battery of a vehicle, the charging control apparatus comprising an acquiring section configured to acquire information concerning a location and business hours of a charging stand, the charging stand configured to perform charging with a higher speed than predetermined charging; a selecting section configured to select a first charging stand, from among a plurality of the charging stands, based on the business hours and a distance from a location of the vehicle; a determining section configured to determine whether an amount of power needed for the vehicle to reach the first charging stand is held by the battery of the vehicle; and a charging control section configured to, if the amount of power needed for the vehicle to reach the first charging stand is not held in the battery, perform a first charging to cause the battery to hold the power needed for the vehicle to reach the first charging stand, wherein the charging control section is configured to perform the first charging in a manner that an amount of power held in the battery does not exceed the amount of power needed for the vehicle to reach the first charging stand by an amount greater than or equal to a predetermined value.

A charging control method according to another aspect of the present invention comprises a step of selecting a first charging stand from among a plurality of charging stands configured to perform charging at a higher speed than predetermined charging, based on business hours and a distance from a location of a vehicle; a step of determining whether an amount of power needed for the vehicle to reach the first charging stand is held by a battery of the vehicle; and a step of, if the amount of power needed for the vehicle to reach the first charging stand is not held in the battery, performing a first charging to cause the battery to hold the power needed for the vehicle to reach the first charging stand, in a manner that an amount of power held in the battery does not exceed the amount of power needed for the vehicle to reach the first charging stand by an amount greater than or equal to a predetermined value.

A program according to another aspect of the present invention causes a computer to perform a step of selecting a first charging stand from among a plurality of charging stands configured to perform charging at a higher speed than predetermined charging, based on business hours and a distance from a location of a vehicle; a step of determining whether an amount of power needed for the vehicle to reach the first charging stand is held by a battery of the vehicle; and a step of, if the amount of power needed for the vehicle to reach the first charging stand is not held in the battery, performing a first charging to cause the battery to hold the power needed for the vehicle to reach the first charging stand, in a manner that an amount of power held in the battery does not exceed the amount of power needed for the vehicle to reach the first charging stand by an amount greater than or equal to a predetermined value.

According to the present invention, it is possible to provide a charging control apparatus, a charging control method, and a program that make it possible to ensure that an amount of power necessary for emergencies is held in a battery.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a block diagram showing a vehicle including the charging control apparatus according to an embodiment.

FIG. 2 shows an example of the positional relationship between the vehicle and charging stands.

FIG. 3 is a flow chart showing an operation of the charging control apparatus according to an embodiment.

FIG. 4 shows an example of the operation of the charging control apparatus according to an embodiment.

### DESCRIPTION OF THE PREFERRED EMBODIMENTS

The following describes examples of preferred embodiments of the vehicle control apparatus according to the present invention, while referencing the accompanying drawings.

### First Embodiment

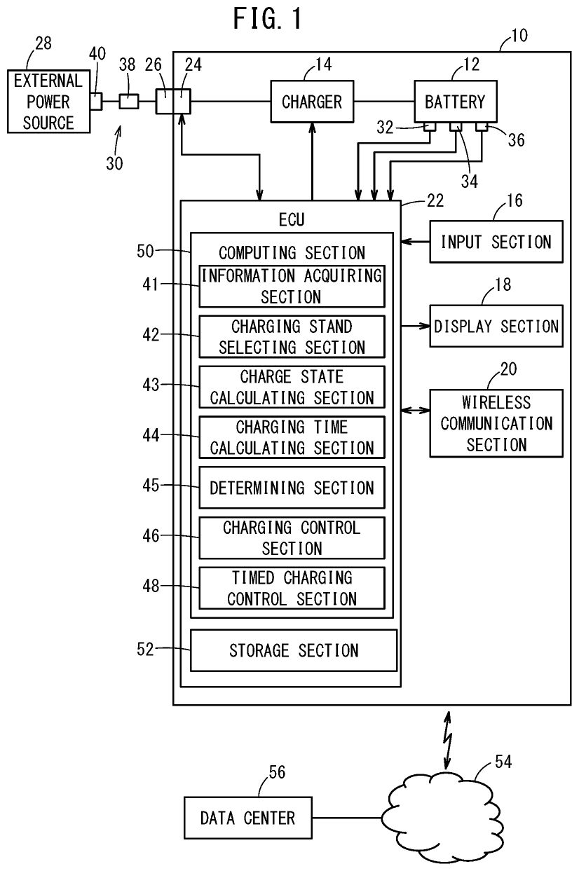

The following describes a charging control apparatus, a charging control method, and a program according to an embodiment of the present invention, using the accompanying drawings. FIG. 1 is a block diagram showing a vehicle including the charging control apparatus according to the present embodiment.

A vehicle 10 includes a battery 12, a charger 14, an input section 16, a display section 18, a wireless communication section 20, and an ECU (Electronic Control Unit) 22.

The battery 12 includes a plurality of cells (not shown in the drawing). The plurality of cells included in the battery 12 are connected in series. Each cell uses a nickel storage battery or lithium storage battery. The battery 12 includes a voltage sensor 32 that detects a voltage of the battery 12, a temperature sensor 34 that detects temperature of the battery 12, and a current sensor 36 that detects a charging current or discharging current of the battery 12. The battery 12 supplies power to a traction motor or the like (not shown in the drawings) via an inverter (not shown in the drawings).

The vehicle 10 includes a charging port 24. The charging port 24 is used to receive power supplied from an external power source 28, via a charging cable 30 or the like. The external power source 28 is a domestic power source, for example, but is not limited to this. The charging cable 30 includes a power source plug 40, a control box 38, and a charging connector 26, for example. The power source plug 40 is connected to a charging socket (not shown in the drawing) of the external power source 28. The charging connector 26 is connected to the charging port 24. The charging port 24 includes a sensor (not shown in the drawings) that detects whether the charging connector 26 is connected. By supplying the vehicle 10 with power from the external power source 28 via the charging cable 30, it is possible to perform predetermined charging, i.e., normal charging that is not high-speed charging.

The charger 14 includes a converter that converts the AC power supplied from the external power source 28 into DC power and a boost circuit that boosts or elevates the DC power. When the charging connector 26 of the charging cable 30 connected to the external power source 28 is connected to the charging port 24, the charger 14 performs charging of the battery 12 using the power supplied from the external power source 28. The starting and stopping of the charging by the charger 14 are controlled by a charging control section 46. The starting and stopping of the charging by the charger 14 can also be controlled by a timed charging control section 48.

The input section 16 is used by the user to perform input manipulations. The charging start timing and the charging end timing can be input via the input section 16. The input section 16 can be formed by a keypad, push buttons, or the like, but is not limited to this. A signal corresponding to the input manipulation performed by the user is supplied from the input section 16 to the ECU 22.

The display section 18 displays the charging start timing, the charging end timing, and the like set by the user. The display section 18 can be formed by an LED (Light Emitting Diode) provided in an installment panel, a drive circuit for the LED, and the like, but is not limited to this.

The wireless communication section (communication section) 20 is used to perform communication with a data center (data management center) 56, via the Internet 54 or the like. The data center 56 holds information indicating the positions of charging stands that include high-speed chargers capable of high-speed charging. Furthermore, the data center 56 holds information concerning the business hours of each charging stand, specifically the business start timing, business end timing, and the like. The data center 56 may also hold information indicating the operating conditions or the like of each charging stand. The information indicating the operating conditions of a charging stand is, specifically, information indicating availability of a high-speed charger of the charging stand.

The ECU 22 performs control of the entire charging control apparatus of the present embodiment, and performs predetermined processes. The ECU 22 includes a computing section 50 and a storage section 52. The computing section 50 is formed by a CPU (Central Processing Unit), for example. The computing section 50 performs predetermined computational processes. The computing section 50 generates signals to be supplied to the charger 14, the display section 18, the wireless communication section 20, the charging port 24, and the like, based on the results of the computational processes.

The computing section 50 includes an information acquiring section 41, a charging stand selecting section 42, a charge state calculating section 43, a charging time calculating section 44, a determining section 45, the charging control section 46, and the timed charging control section 48. The information acquiring section 41, the charging stand selecting section 42, the charge state calculating section 43, the charging time calculating section 44, the determining section 45, the charging control section 46, and the timed charging control section 48 are realized by the computing section 50 executing a program stored in the storage section 52.

The storage section 52 includes a RAM (Random Access Memory) (not shown in the drawings), a ROM (Read Only Memory) (not shown in the drawings), a flash memory, and the like. Data to be provided for each type of computational process and the like is stored in the RAM, for example. Programs, tables, maps, and the like are stored in the ROM, for example.

Signals output from the input section 16 are input to the input port of the ECU 22. Furthermore, signals output respectively by the voltage sensor 32, the temperature sensor 34, and the current sensor 36 are input to the input port of the ECU 22. A signal output from a sensor (not shown in the drawing) included in the charging port 24 is input to the input port of the ECU 22. A control signal output from the output port of the ECU 22 is input to the charger 14. A display control signal output from the output port of the ECU 22 is input to the display section 18. Signals are input and output between the information acquiring section 41 and the wireless communication section 20, via the input/output port of the ECU 22.

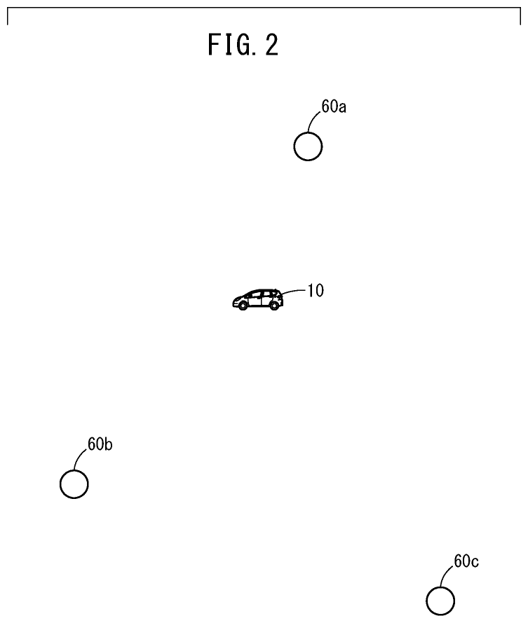

FIG. 2 shows an example of a positional relationship between the vehicle and charging stands. The information acquiring section 41 acquires information supplied from the data center 56, as described further below. The charging stand selecting section 42 selects a first charging stand 60 as described below, for example, based on the information supplied from the data center 56. Specifically, the charging stand selecting section 42 selects the first charging stand 60 (not shown in the drawings) from among a plurality of charging stands 60, based on the business hours and the distance from the location of the vehicle 10. When describing a charging stand in general, the reference numeral 60 is used, and when describing individual charging stands, the reference numerals 60a to 60c are used. The first charging stand 60 is the closest charging stand among the plurality of charging stands 60, for example. The charging stand selecting section 42 can select the first charging stand 60 from among the plurality of charging stands 60 further based on the operating conditions of the charging stands 60. Here, an example is described in which the charging stand 60a is selected as the first charging stand.

The charge state calculating section (charge state determining section) 43 calculates the SOC (State Of Charge) of the battery 12, based on the detection values of the voltage sensor 32, the temperature sensor 34, the current sensor 36, and the like.

The determining section 45 determines whether the amount of power (remaining battery life) needed for the vehicle 10 to reach the first charging stand 60a is held in the battery 12 of the vehicle 10. If the amount of power needed for the vehicle 10 to reach the first charging stand 60a is less than the amount of power held in the battery 12, the determining section 45 makes a determination in the manner described below. Specifically, the determining section 45 determines that the amount of power needed for the vehicle 10 to reach the first charging stand 60a is held in the battery 12. If the amount of power needed for the vehicle 10 to reach the first charging stand 60a is greater than or equal to the amount of power held in the battery 12, the determining section 45 makes a determination in the manner described below. Specifically, the determining section 45 determines that the amount of power needed for the vehicle 10 to reach the first charging stand 60a is not held in the battery 12.

If the amount of power needed for the vehicle 10 to reach the first charging stand 60a is not held in the battery 12, the charging control section 46 performs a process such as described below. Specifically, in such a case, the charging control section 46 performs a first charging to cause the battery 12 to hold the amount of power needed for the vehicle 10 to reach the first charging stand 60a. At this time, the charging control section 46 performs the first charging such that the amount of power held by the battery 12 does not exceed the amount of power needed for the vehicle 10 to reach the first charging stand 60a by an amount greater than or equal to a predetermined value. Since charging beyond the necessary amount is not performed, degradation of the battery 12 is prevented.

The charging stand selecting section 42 can further select a second charging stand 60 from among the plurality of charging stands 60, based on the business hours and the distance from the location of the vehicle 10. For example, the business end timing of the second charging stand 60 is later than the business end timing of the first charging stand 60, and the distance from the location of the vehicle 10 to the second charging stand 60 is greater than the distance from the location of the vehicle 10 to the first charging stand 60. Here, an example is described in which the charging stand 60b is selected as the second charging stand.

The determining section 45 can determine whether the amount of power needed for the vehicle 10 to reach the second charging stand 60b is held in the battery 12. If the amount of power needed for the vehicle 10 to reach the second charging stand 60b is not held in the battery 12, the charging control section 46 performs a process such as described below. Specifically, in such a case, the charging control section 46 performs a second charging to cause the battery 12 to hold the amount of power needed for the vehicle 10 to reach the second charging stand 60b, after the first charging. The charging control section 46 performs the second charging such that the amount of power held by the battery 12 does not exceed the amount of power needed for the vehicle 10 to reach the second charging stand 60b by an amount greater than or equal to a predetermined value. Since charging beyond the necessary amount is not performed, degradation of the battery 12 is prevented.

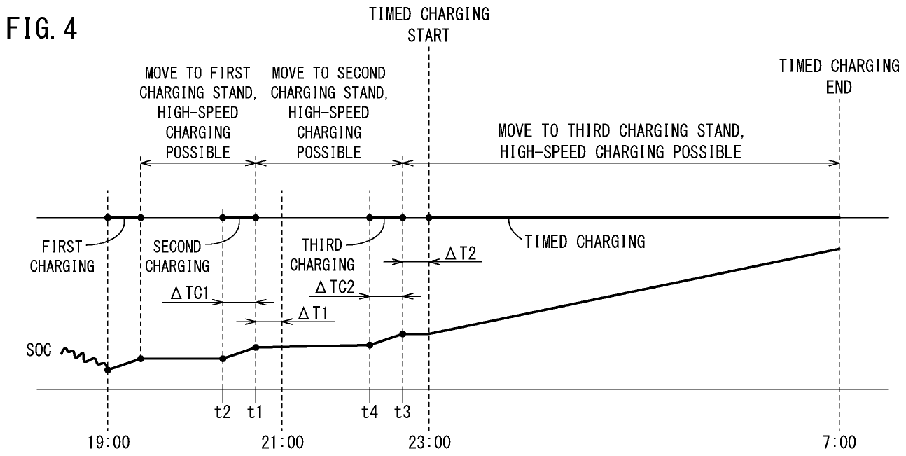

The charging control section 46 completes the second charging by a first timing t1 (see FIG. 4) that is a first predetermined time (time period) ΔT1 (see FIG. 4) earlier than the business end timing of the first charging stand 60, for example. The first predetermined time ΔT1 is determined based on the time needed for the vehicle 10 to reach the first charging stand 60a, for example. The first predetermined time ΔT1 may be determined further based on the time needed to charge the battery 12 at the first charging stand 60a.

The charging time calculating section 44 calculates a first charging time ΔTC1 (see FIG. 4) that is the time needed for the second charging. The charging control section 46 starts the second charging at a second timing t2 (see FIG. 4) that is the first charging time ΔTC1 earlier than the first timing t1, for example. If the second charging is started at such a second timing t2, the second charging can be completed at the first timing t1.

The charging stand selecting section 42 can further select a third charging stand 60 from among the plurality of charging stands 60, based on the business hours and the distance from the location of the vehicle 10. For example, the business end timing of the third charging stand 60 is later than the business end timing of the second charging stand 60, and the distance from the location of the vehicle 10 to the third charging stand 60 is greater than the distance from the location of the vehicle 10 to the second charging stand 60. Here, an example is described in which the charging stand 60c is selected as the third charging stand.

The determining section 45 can further determine whether the amount of power needed for the vehicle 10 to reach the third charging stand 60c is held in the battery 12. If the amount of power needed for the vehicle 10 to reach the third charging stand 60c is not held in the battery 12, the charging control section 46 performs a process such as described below. Specifically, in such a case, the charging control section 46 performs a third charging to cause the battery 12 to hold the amount of power needed for the vehicle 10 to reach the third charging stand 60c, after the second charging. The charging control section 46 performs the third charging such that the amount of power held by the battery 12 does not exceed the amount of power needed for the vehicle 10 to reach the third charging stand 60c by an amount greater than or equal to a predetermined value. Since charging beyond the necessary amount is not performed, degradation of the battery 12 is prevented.

The charging control section 46 completes the third charging by a third timing t3 (see FIG. 4) that is a second predetermined time ΔT2 (see FIG. 4) earlier than the business end timing of the second charging stand 60b, for example. The second predetermined time ΔT2 is determined based on the time needed for the vehicle 10 to reach the second charging stand 60b, for example. The second predetermined time ΔT2 may be determined further based on the time needed to charge the battery 12 at the second charging stand 60b.

The charging time calculating section 44 calculates a second charging time ΔTC2 (see FIG. 4) that is the time needed for the third charging. The charging control section 46 starts the third charging at a fourth timing t4 (see FIG. 4) that is the second charging time ΔTC2 earlier than the third timing t3, for example. If the third charging is started at such a fourth timing t4, the third charging can be completed at the third timing t3.

The timed charging control section 48 performs a charging reservation setting for the battery 12, based on the manipulations performed by the user using the input section 16. Specifically, the charging start timing, the charging end timing, and the like are set. Furthermore, days of the week on which charging is to be performed and dates on which charging is to be performed may also be set. The timed charging control section 48 performs timed charging of the battery 12. For the timed charging, the charging is started at the charging start timing and the charging is stopped at the charging end timing. Information relating to the charging reservation is stored in a flash memory or the like provided to the storage section 52 of the ECU 22, to preserve this information even when the power source of the ECU 22 is cut off. The charging by the charging control section 46 is performed before the timed charging by the timed charging control section 48.

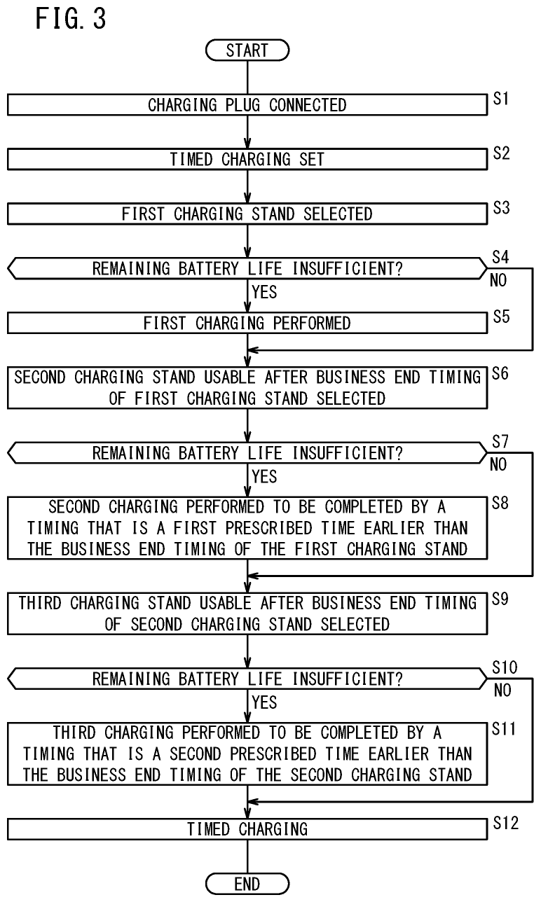

The following describes the operation of the charging control apparatus according to the present embodiment, using the accompanying drawings. FIG. 3 is a flow chart showing the operation of the charging control apparatus according to the present embodiment. FIG. 4 shows an example of the operation of the charging control apparatus according to the present embodiment.

At step S1, the vehicle 10 is connected to the external power source 28 via the charging cable 30. The external power source 28 is a domestic power source or the like, as described above. The charging connector 26 of the charging cable 30 is connected to the charging port 24, and the power source plug 40 of the charging cable 30 is connected to a socket of the external power source 28.

At step S2, the settings for the timed charging are set by the user, via the input section 16. The charging start timing is set to be 23:00, for example. The charging end timing is set to be the next day at 7:00, for example. The current timing, charging start timing, and charging end timing are not limited to the above examples.

At step S3, the selection of the first charging stand 60 is performed in the manner described below. Specifically, first, the information acquiring section 41 makes a request to the data center 56 to provide the information relating to the charging stands 60. The information acquiring section 41 transmits the information indicating the location of the vehicle 10 to the data center 56, along with this request. The data center 56 extracts a charging stand 60 positioned within a predetermined distance from the location of the vehicle 10, from among the plurality of charging stand 60. If there are a plurality of charging stands 60 that fulfill this condition, the data center 56 extract the charging stands 60 and provides the information acquiring section 41 with the information concerning the extracted charging stands 60 via the wireless communication section 20. This information includes a name of the charging stand 60, an ID of the charging stand 60, a location of the charging stand 60, the business hours of the charging stand 60, the operating conditions of the charging stand 60, and the like.

The data center 56 may determine whether a charging stand 60 is open for business at the current timing based on the information relating to the business hours of this charging stand 60. If it is currently outside the business hours of this charging stand 60, the data center 56 does not need to extract this charging stand 60.

The charging stand selecting section 42 selects the first charging stand 60 in the following manner, for example, based on the information supplied from the data center 56. Specifically, the charging stand selecting section 42 selects the charging stand 60 that is closest to the location of the vehicle 10, i.e., the closest charging stand 60, from among the plurality of charging stands 60 extracted by the data center 56. The selection of the closest charging stand 60 is performed based on the information concerning the locations of the charging stands 60.

The charging stand selecting section 42 determines whether the selected closest charging stand 60 fulfills the condition concerning business hours, based on the information concerning the business hours of this charging stand 60. The condition concerning the business hours is that the timing at which the process of step S3 is performed is earlier than the first timing t1, which is the first predetermined time ΔT1 earlier than the business end timing of this charging stand 60, for example. The first predetermined time ΔT1 can be the sum of the time needed for the vehicle 10 to reach this charging stand 60 and the time needed to charge the battery 12 at this charging stand 60, for example. As an example, in a case where the time needed for the vehicle 10 to reach the charging stand 60 is 10 minutes and the time needed to perform charging at the charging stand 60 is 30 minutes, the first predetermined time ΔT1 is 40 minutes. If the business hours of this charging stand 60 are from 9:00 to 21:00, for example, the first timing t1 that is the first predetermined time ΔT1 before the business end timing of the charging stand 60 is 20:20. If the current timing is 19:00, for example, the current timing is before 20:20 that is the first timing t1 that is the first time ΔT1 earlier than the business end timing of this charging stand 60. In such a case, this charging stand 60 fulfills the condition concerning the business time.

The condition concerning the business hours is not limited to the condition described above. As an example, as long as the vehicle 10 can reach the charging stand 60 by the business end timing, if the charging can be performed until after the business end timing, the time needed for the vehicle 10 to reach this charging stand 60 may be set to be the first predetermined time ΔT1.

If the selected closest charging stand 60 fulfills this condition concerning business hours, the charging stand selecting section 42 determines whether it is possible to use this charging stand 60 based on the information indicating the operating conditions of this charging stand 60. Specifically, the charging stand selecting section 42 determines whether this charging stand 60 can be used based on the availability of a high-speed charger (not shown in the drawing) of this charging stand 60. If the charging stand 60 can be used, the charging stand selecting section 42 selects this charging stand 60 as the first charging stand.

If the closest charging stand 60 does not fulfill the condition described above, the charging stand selecting section 42 selects the second closest charging stand 60 from the location of the vehicle 10, from among the plurality of charging stands 60 extracted by the data center 56. Then, if this selected charging stand 60 fulfills the condition described above, the charging stand selecting section 42 selects this charging stand 60 as the first charging stand 60.

If this charging stand 60 does not fulfill the condition described above, the charging stand selecting section 42 selects the third closest charging stand 60 from the location of the vehicle 10, from among the plurality of charging stands 60 extracted by the data center 56. The determination described above is then performed in the same manner. Such a process is performed until the selection of the first charging stand 60 is completed.

Here, an example is described in which the operating conditions of each charging stand 60 are considered when selecting the first charging stand 60, but the present embodiment is not limited to this. As an example, the first charging stand 60 may be selected without considering the operating conditions of the charging stands 60. Furthermore, an example is described here in which the closest charging stand 60a (see FIG. 2) is selected as the first charging stand.

At step S4, the determining section 45 determines whether the remaining battery life is insufficient. Specifically, the determining section 45 determines whether the amount of power needed for the vehicle 10 to reach the first charging stand 60a is held in the battery 12 of the vehicle 10. The amount of power needed for the vehicle 10 to reach the first charging stand 60a is the sum of the amount of power needed for the vehicle 10 to move to the first charging stand 60a and the amount of power needed for the vehicle 10 to operate the air conditioner or the like while moving, for example. The SOC indicating the remaining battery life is calculated in advance by the charge state calculating section 43. If the amount of power needed for the vehicle 10 to reach the first charging stand 60a is not held in the battery 12 of the vehicle 10 (YES at step S4), the process moves to step S5. If the amount of power needed for the vehicle 10 to reach the first charging stand 60a is held in the battery 12 of the vehicle 10 (NO at step S4), the process moves to step S6.

At step S5, the charging control section 46 immediately performs the first charging to cause the battery 12 to hold the amount of power needed for the vehicle 10 to reach the first charging stand 60a. At this time, the charging control section 46 performs the first charging such that the amount of power held by the battery 12 does not exceed the amount of power needed for the vehicle 10 to reach the first charging stand 60a by an amount greater than or equal to a predetermined value. In this way, the first charging is performed without relation to the charging start timing and the charging end timing of the timed charging.

At step S6, the selection of the second charging stand 60 that can be used after the business end timing of the first charging stand 60a is performed as described below. The charging stand selecting section 42 selects the second charging stand 60 in the manner described below, for example, based on the information supplied from the data center 56. Specifically, as an example, the charging stand selecting section 42 selects the charging stand 60 that is next closest to the vehicle 10, compared to the first charging stand 60a, from among the plurality of charging stands 60 extracted by the data center 56.

The charging stand selecting section 42 determines whether the business end timing of the selected charging stand 60 is later than the business end timing of the first charging stand 60a, based on the information concerning the business hours of these charging stands 60. If the business end timing of the selected charging stand 60 is later than the business end timing of the first charging stand 60a, the charging stand selecting section 42 performs a process such as described below. Specifically, in such a case, the charging stand selecting section 42 determines whether the charging stand 60 whose distance from the vehicle 10 is next shortest compared to the first charging stand 60a fulfills the condition concerning the business hours, based on the information concerning the business hours of this charging stand 60. As an example, the condition concerning the business hours is that the timing at which the process of step S6 is performed is earlier than the third timing t3, which is the second predetermined time ΔT2 earlier than the business end timing of this charging stand 60. The second predetermined time ΔT2 can be the sum of the time needed for the vehicle 10 to reach the charging stand 60 and the time needed to charge the battery 12 at this charging stand 60, for example. As an example, in a case where the time needed for the vehicle 10 to reach the charging stand 60 is 15 minutes and the time needed to charge the battery 12 at the charging stand 60 is 30 minutes, the second predetermined time ΔT2 is 45 minutes. If the business end timing of this charging stand 60 is 23:00, for example, the third timing t3 that is the second predetermined time ΔT2 before the business end timing of the charging stand 60 is 22:15. If the timing at which the process of step S6 is performed is 20:00, for example, the timing at which the process of step S6 is performed is before 22:15 that is the third timing t3 that is the second time ΔT2 earlier than the business end timing of this charging stand 60. In such a case, this charging stand 60 fulfills the condition concerning the business time.

The condition concerning the business hours is not limited to the above examples. As another example, as long as the vehicle 10 can reach the charging stand 60 by the business end timing, if the charging can be performed even after the business end timing, the time needed for the vehicle 10 to reach the charging stand 60 may be the second predetermined time ΔT2.

If the charging stand 60 that is next closest to the vehicle 10, compared to the first charging stand 60a, fulfills the condition concerning the business hours, the charging stand selecting section 42 determines whether this charging stand 60 can be used, based on the operating conditions of this charging stand 60. Specifically, the charging stand selecting section 42 determines whether it is possible to use this charging stand 60, based on the availability of the high-speed charger of this charging stand 60.

If the information indicating the operating conditions of the charging stand 60 supplied from the data center 56 at step S3 is old, the information acquiring section 41 makes a request to the data center 56 to provide new information concerning the operation conditions of this charging stand 60. In this case, the data center 56 provides the information acquiring section 41 with the new information concerning the operating conditions of this charging stand 60. If it is possible to use this charging stand 60, the charging stand selecting section 42 selects this charging stand 60 as the second charging stand.

If the charging stand 60 does not fulfill the conditions such as described above, the charging stand selecting section 42 selects the next closest charging stand 60 from the location of the vehicle 10, from among the plurality of charging stands 60 extracted by the data center 56. If this selected charging stand 60 fulfills the conditions such as described above, this charging stand 60 is selected as the second charging stand.

If this charging stand 60 does not fulfill the conditions such as described above, the charging stand selecting section 42 selects the next closest charging stand 60 from the location of the vehicle 10, from among the plurality of charging stands 60 extracted by the data center 56. The determination such as described above is then performed in the same manner. This process is performed until the selection of the second charging stand 60 is completed.

Here, an example is described in which the operating conditions of each charging stand 60 are considered when selecting the second charging stand 60, but the present embodiment is not limited to this. As an example, the second charging stand 60 may be selected without considering the operating conditions of the charging stands 60. Furthermore, an example is described here in which the charging stand 60b (see FIG. 2) is selected as the second charging stand.

At step S7, the determining section 45 determines whether the remaining battery life is insufficient. Specifically, the determining section 45 determines whether the amount of power needed for the vehicle 10 to reach the second charging stand 60b is held in the battery 12 of the vehicle 10. The amount of power needed for the vehicle 10 to reach the second charging stand 60b is the sum of the amount of power needed for the vehicle 10 to move to the second charging stand 60b and the amount of power needed for the vehicle 10 to operate the air conditioner or the like while moving. If the amount of power needed for the vehicle 10 to reach the second charging stand 60b is not held in the battery 12 of the vehicle 10 (YES at step S7), the process moves to step S8. If the amount of power needed for the vehicle 10 to reach the second charging stand 60b is held in the battery 12 of the vehicle 10 (NO at step S7), the process moves to step S9.

At step S8, the charging control section 46 completes the second charging by the first timing t1 that is the first predetermined time ΔT1 earlier than the business end timing of the first charging stand 60a. Specifically, the charging time calculating section 44 calculates the first charging time ΔTC1, which is the time needed for the second charging. For example, the charging control section 46 starts the second charging at the second timing t2 that is the first charging time ΔTC1 earlier than the first timing t1. If the second charging is started at such a second timing t2, the second charging can be completed by the first timing t1. The reason that the second charging is completed by the first timing t1 that is the first predetermined time ΔT1 earlier than the business end timing of the first charging stand 60a is as described below. Specifically, the reason is that if the current timing (the present point of time) is after the first timing t1 that is the first predetermined time ΔT1 earlier than the business end timing of the first charging stand 60a, it becomes necessary to use the second charging stand 60b. In other words, before the first timing t1 that is the first predetermined time ΔT1 earlier than the business end timing of the first charging stand 60a, it is possible for the vehicle 10 to move to the first charging stand 60a and to complete the charging using the first charging stand 60a. However, if the current timing is after the first timing t1 that is the first predetermined time ΔT1 earlier than the business end timing of the first charging stand 60a, the following situation occurs. Specifically, even though the vehicle 10 is able to reach the first charging stand 60a before the business end timing, it is impossible to sufficiently charge the battery 12 using the first charging stand 60a. Accordingly, if the current timing is after the first timing t1 that is the first predetermined time ΔT1 earlier than the business end timing of the first charging stand 60a, it becomes necessary to use the second charging stand 60b. Therefore, the second charging is completed by a timing that does not result in the need to use the second charging stand 60b, i.e., the first timing t1 that is the first predetermined time ΔT1 earlier than the business end timing of the first charging stand 60a.

As described above, the first predetermined time ΔT1 can be the sum of the time needed for the vehicle 10 to reach the first charging stand 60a and the time needed to charge the battery 12 using the first charging stand 60a, for example. As an example, in a case where the time needed for the vehicle 10 to reach the first charging stand 60a is 10 minutes and the time needed to charge the battery 12 at the first charging stand 60 is 30 minutes, the first predetermined time ΔT1 is 40 minutes. If the business end timing of the first charging stand 60a is 21:00, for example, the timing that is the first predetermined time ΔT1 earlier than the business end timing of the first charging stand 60a is 20:20. In this case, the second charging is completed by 20:20. The charging control section 46 performs the second charging such that the amount of power held by the battery 12 does not exceed the amount of power needed for the vehicle 10 to reach the second charging stand 60b by an amount greater than or equal to a predetermined value. Since charging beyond the necessary amount is not performed, degradation of the battery 12 is prevented.

At step S9, the selection of the third charging stand 60 that can be used after the business end timing of the second charging stand 60b is performed in the following manner. The charging stand selecting section 42 selects the third charging stand 60 in the following manner, for example, based on the information supplied from the data center 56. Specifically, the charging stand 60 that is next closest to the location of the vehicle 10, compared to the second charging stand 60b, is selected from among the plurality of charging stands 60 extracted by the data center 56, for example.

The charging stand selecting section 42 determines whether the business end timing of this selected charging stand 60 is later than the business end timing of the second charging stand 60b, based on the information concerning the business end timings of these charging stands 60. If the business end timing of the selected charging stand 60 is later than business end timing of the second charging stand 60b, the charging stand selecting section 42 performs a process such as described below. Specifically, in such a case, the charging stand selecting section 42 determines whether the charging stand 60 that is next closest to the location of the vehicle 10, compared to the second charging stand 60b, fulfills the conditions concerning the business hours, based on the information concerning the business hours of this charging stand 60. The condition concerning the business hours is that the timing at which the process of step S9 is to be performed is earlier than the fifth timing t5 that is the third predetermined time ΔT3 earlier than the business end timing of this charging stand 60, for example. The third predetermined time ΔT3 can be the sum of the time needed for the vehicle 10 to reach this charging stand 60 and the time needed to charge the battery 12 at this charging stand 60, for example. As an example, in a case where the time needed for the vehicle 10 to reach the this charging stand 60 is 20 minutes and the time needed to charge the battery 12 is 30 minutes, the third predetermined time ΔT3 is 50 minutes. If this charging stand 60 operates 24 hours a day, the timing at which the process of step S9 is performed is earlier than the fifth timing t5 that is the third predetermined time ΔT3 than the business end timing of this charging stand 60. In such a case, this charging stand 60 fulfills the condition concerning the business hours.

The condition concerning the business hours is not limited to the above example. For example, as long as the vehicle 10 can arrive at this charging stand 60 by the business end timing, if the charging can be performed even after the business end timing, the time needed for the vehicle 10 to reach this charging stand 60 may be the third predetermined time ΔT3.

If the charging stand 60 that is next closest to the location of the vehicle 10, compared to the second charging stand 60b, fulfills the condition concerning the business hours, the charging stand selecting section 42 determines whether this charging stand 60 can be used, based on the operating conditions of this charging stand 60. Specifically, the charging stand selecting section 42 determines whether the charging stand 60 can be used based on the availability of the high-speed charger of this charging stand 60.

If the information indicating the operating conditions of the charging stand 60 supplied from the data center 56 at step S3 or step S6 is old, the information acquiring section 41 makes a request to the data center 56 to provide new information concerning the operation conditions of this charging stand 60. In this case, the data center 56 provides the information acquiring section 41 with the new information concerning the operating conditions of this charging stand 60, via the wireless communication section 20. If it is possible to use this charging stand 60, the charging stand selecting section 42 selects this charging stand 60 as the third charging stand.

If this charging stand 60 does not fulfill the conditions such as described above, the charging stand selecting section 42 performs a process such as described below. Specifically, the charging stand selecting section 42 selects the next closest charging stand 60 from the location of the vehicle 10, from among the plurality of charging stands 60 extracted by the data center 56. If this selected charging stand 60 fulfills the conditions such as described above, the charging stand selecting section 42 selects this charging stand 60 as the third charging stand.

If this charging stand 60 does not fulfill the conditions such as described above, the charging stand selecting section 42 selects the next closest charging stand 60 from the location of the vehicle 10, from among the plurality of charging stands 60 extracted by the data center 56. The determination such as described above is then performed in the same manner. This process is performed until the selection of the third charging stand 60 is completed.

Here, an example is described in which the operating conditions of each charging stand 60 are considered when selecting the third charging stand 60, but the present embodiment is not limited to this. As an example, the third charging stand 60 may be selected without considering the operating conditions of the charging stands 60. Furthermore, an example is described here in which the charging stand 60c (see FIG. 2) is selected as the third charging stand.

At step S10, the determining section 45 determines whether the remaining battery life is insufficient. Specifically, the determining section 45 determines whether the amount of power needed for the vehicle 10 to reach the third charging stand 60c is held in the battery 12 of the vehicle 10. The amount of power needed for the vehicle 10 to reach the third charging stand 60c is the sum of the amount of power needed for the vehicle 10 to move to the third charging stand 60c and the amount of power needed for the vehicle 10 to operate the air conditioner or the like while moving, for example. If the amount of power needed for the vehicle 10 to reach the third charging stand 60c is not held in the battery 12 of the vehicle 10 (YES at step S10), the process moves to step S11. If the amount of power needed for the vehicle 10 to reach the third charging stand 60c is held in the battery 12 of the vehicle 10 (NO at step S10), the process moves to step S12.

At step S11, the charging control section 46 completes the third charging by the third timing t3 that is the second predetermined time ΔT2 earlier than the business end timing of the second charging stand 60b. Specifically, the charging time calculating section 44 calculates the second charging time ΔTC2, which is the time needed for the third charging. For example, the charging control section 46 starts the third charging at a fourth timing t4 that is the second charging time ΔTC2 earlier than the third timing t3. If the third charging is started at such a fourth timing t4, the third charging can be completed by the third timing t3. The reason that the third charging is completed by the third timing t3 that is the second predetermined time ΔT2 earlier than the business end timing of the second charging stand 60b is as described below. Specifically, the reason is that if the current timing is after the third timing t3 that is the second predetermined time ΔT2 earlier than the business end timing of the second charging stand 60b, it becomes necessary to use the third charging stand 60c. In other words, before the third timing t3 that is the second predetermined time ΔT2 earlier than the business end timing of the second charging stand 60b, it is possible for the vehicle 10 to move to the second charging stand 60b and to complete the charging using the second charging stand 60b. However, if the current timing is after the third timing t3 that is the second predetermined time ΔT2 earlier than the business end timing of the second charging stand 60b, the following situation occurs. Specifically, even though the vehicle 10 is able to reach the second charging stand 60b before the business end timing, it is impossible to sufficiently charge the battery 12 using the second charging stand 60b. Accordingly, if the current timing is after the third timing t3 that is the second predetermined time ΔT2 earlier than the business end timing of the second charging stand 60b, it becomes necessary to use the third charging stand 60c. Therefore, the third charging is completed by a timing that does not result in the need to use the third charging stand 60c, i.e., the third timing t3 that is the second predetermined time ΔT2 earlier than the business end timing of the second charging stand 60b.

As described above, the second predetermined time ΔT2 can be the sum of the time needed for the vehicle 10 to reach the second charging stand 60b and the time needed to charge the battery 12 using the second charging stand 60b, for example. As an example, in a case where the time needed for the vehicle 10 to reach the second charging stand 60b is 15 minutes and the time needed to charge the battery 12 at the second charging stand 60b is 30 minutes, the second predetermined time ΔT2 is 45 minutes. If the business end timing of the second charging stand 60b is 23:00, for example, the third timing t3 that is the second predetermined time ΔT2 earlier than the business end timing of the second charging stand 60b is 22:15. In this case, the third charging is completed by 22:15. The charging control section 46 performs the third charging such that the amount of power held by the battery 12 does not exceed the amount of power needed for the vehicle 10 to reach the third charging stand 60c by an amount greater than or equal to a predetermined value. Since charging beyond the necessary amount is not performed, degradation of the battery 12 is prevented.

At step S12, the timed charging control section 48 performs the timed charging. If the charging start timing is set to 23:00, the timed charging is started at 23:00. In this way, the process shown in FIG. 4 is completed.

In this way, according to the present embodiment, the first charging stand 60 is selected from among the plurality of charging stands 60, based on the business hours and the distance from the location of the vehicle 10. Then, if the amount of power needed for the vehicle 10 to reach the first charging stand 60 is not held in the battery 12, a process such as described below is performed. Specifically, the first charging is performed to cause the battery 12 to hold the amount of power needed for the vehicle 10 to reach the first charging stand 60. Therefore, according to the present embodiment, if the need to use the vehicle 10 arises, it is possible for the vehicle 10 to reliably reach the first charging stand 60 at which high-speed charging can be performed, to quickly charge the battery 12 using the first charging stand 60. Furthermore, according to the present embodiment, the first charging is performed such that the amount of power held by the battery 12 does not exceed the amount of power needed for the vehicle 10 to reach the first charging stand 60 by an amount greater than or equal to a predetermined value. Since charging beyond the necessary amount is not performed, degradation of the battery 12 is prevented.

### [Modification of the Embodiment]

The present invention is not limited to the embodiment described above, and can be modified in various ways.

For example, the above embodiment is an example in which the selection of the second charging stand 60 is performed after completion of the first charging and the selection of the third charging stand 60 is performed after completion of the second charging, but the present invention is not limited to this. For example, when selecting the first charging stand 60, the selection of the second charging stand 60 and the selection of the third charging stand 60 may be performed along with the selection of the first charging stand 60.

The above embodiment is an example in which timed charging is performed, but it is also acceptable to not perform timed charging. For example, the amount of power needed for the vehicle 10 to reach a charging stand 60 may be held in advance in the battery 12. Then, when using the vehicle 10, the vehicle 10 may first move to the charging stand 60 to perform high-speed charging, and the vehicle 10 may then be used after completing the high-speed charging. Furthermore, a process such as described below may be performed. Specifically, when there is no plan to use the vehicle 10, the amount of power needed for the vehicle 10 to reach the charging stand 60 during an emergency may be held in the battery 12. On the other hand, the timed charging may be performed where there is a plan to use the vehicle 10.

The above embodiment is an example in which the first charging is started without determining whether the first charging would be completed by the timing that is the predetermined time earlier than the business end timing of the first charging stand 60, but the present invention is not limited to this. For example, if the first charging cannot be completed by the timing that is the predetermined time earlier than the business end timing of the first charging stand 60, the first charging stand 60 may be reselected. This predetermined time is determined based on the time needed for the vehicle 10 to reach the first charging stand 60. Furthermore, this predetermined time may be determined based on the time needed to charge the battery 12 at the first charging stand 60.

The following is a summary of the embodiment described above.

The charging control apparatus (22) that performs predetermined charging of the battery (12) of the vehicle (10), the charging control apparatus comprising the acquiring section (41) configured to acquire information concerning a location and business hours of the charging stand (60a, 60b, 60c), the charging stand configured to perform charging with a higher speed than the predetermined charging; the selecting section (42) configured to select the first charging stand (60a), from among the plurality of charging stands, based on the business hours and a distance from a location of the vehicle; the determining section (45) configured to determine whether an amount of power needed for the vehicle to reach the first charging stand is held by the battery of the vehicle; and the charging control section (46) configured to, if the amount of power needed for the vehicle to reach the first charging stand is not held in the battery, perform a first charging to cause the battery to hold the power needed for the vehicle to reach the first charging stand, wherein the charging control section is configured to perform the first charging in a manner that the amount of power held in the battery does not exceed the amount of power needed for the vehicle to reach the first charging stand by an amount greater than or equal to a predetermined value. According to this configuration, if the need to use the vehicle arises, it is possible for the vehicle to reliably reach the first charging stand at which high-speed charging can be performed, to quickly charge the battery using the first charging stand. Furthermore, according to this configuration, since charging beyond the necessary amount is not performed, degradation of the battery is prevented.

The first charging stand may be the closest charging stand among the plurality of charging stands. According to this configuration, when high-speed charging is necessary, it is possible for the vehicle to quickly reach the first charging stand. Furthermore, it is possible to restrict the amount of power charged in the battery during the first charging, and therefore degradation of the battery can be prevented.

The selecting section may be configured to select the first charging stand from among the plurality of charging stands further based on operating conditions thereof. If the first charging stand is selected based on the operating conditions in this manner, it is possible to perform the high-speed charging at the first charging stand more reliably.

The selecting section may be further configured to select a second charging stand (60b) from among the plurality of charging stands, based on the business hours and the distance from the location of the vehicle, the determining section may be further configured to determine whether an amount of power needed for the vehicle to reach the second charging stand is held in the battery, and, if the amount of power needed for the vehicle to reach the second charging stand is not held in the battery, the charging control section may be further configured to perform a second charging, after the first charging, to cause the battery to hold the amount of power needed for the vehicle to reach the second charging stand.

The business end timing of the second charging stand may be later than the business end timing of the first charging stand, and the charging control section may be configured to complete the second charging by a first timing (t1) that is a first predetermined time (ΔT1) earlier than the business end timing of the first charging stand.

The charging control section may be configured to start the second charging at the second timing (t2) that is the first charging time (ΔTC1) earlier than the first timing, the first charging time being the time period needed to perform the second charging. According to this configuration, since charging beyond the necessary amount is not performed, it is possible to prevent the degradation of the battery.

The first predetermined time may be determined based on the time period needed for the vehicle to reach the first charging stand.

The first predetermined time may be determined further based on the time needed to charge the battery at the first charging stand.

The distance from the location of the vehicle to the second charging stand may be greater than the distance from the location of the vehicle to the first charging stand.

The selecting section may be further configured to select a third charging stand (60c) from among the plurality of charging stands, based on the business hours and the distance from the location of the vehicle, the determining section may be further configured to determine whether an amount of power needed for the vehicle to reach the third charging stand is held in the battery, and, if the amount of power needed for the vehicle to reach the third charging stand is not held in the battery, the charging control section may be further configured to perform a third charging, after the second charging, to cause the battery to hold the amount of power needed for the vehicle to reach the third charging stand.

The business end timing of the third charging stand may be later than the business end timing of the second charging stand, and the charging control section may be configured to complete the third charging at a third timing (t3) that is a second predetermined time (ΔT2) earlier than the business end timing of the second charging stand.

The charging control section may be configured to start the third charging at a fourth timing (t4) that is a second charging time (ΔTC2) earlier than the third timing, the second charging time being the time period needed to perform the third charging. According to this configuration, since charging beyond the necessary amount is not performed, it is possible to prevent the degradation of the battery.

The distance from the location of the vehicle to the third charging stand may be greater than the distance from the location of the vehicle to the second charging stand.

The charging control apparatus may further comprise the timed charging control section (48) configured to perform timed charging of the battery, and the charging by the charging control section may be performed before the timed charging by the timed charging control section.

The charging control method comprises a step (S3) of selecting a first charging stand from among a plurality of charging stands configured to perform charging at a higher speed than predetermined charging, based on business hours and a distance from a location of a vehicle; a step (S4) of determining whether an amount of power needed for the vehicle to reach the first charging stand is held by a battery of the vehicle; and a step (S5) of, if the amount of power needed for the vehicle to reach the first charging stand is not held in the battery, performing a first charging to cause the battery to hold the power needed for the vehicle to reach the first charging stand, in a manner that the amount of power held in the battery does not exceed the amount of power needed for the vehicle to reach the first charging stand by an amount greater than or equal to a predetermined value.

The program causes a computer to perform a step of selecting a first charging stand from among a plurality of charging stands configured to perform charging at a higher speed than predetermined charging, based on business hours and a distance from a location of a vehicle; a step of determining whether an amount of power needed for the vehicle to reach the first charging stand is held by a battery of the vehicle; and a step of, if the amount of power needed for the vehicle to reach the first charging stand is not held in the battery, performing a first charging to cause the battery to hold the power needed for the vehicle to reach the first charging stand, in a manner that the amount of power held in the battery does not exceed the amount of power needed for the vehicle to reach the first charging stand by an amount greater than or equal to a predetermined value.

What is claimed is:

1. A charging control apparatus that performs predetermined charging of a battery of a vehicle, the charging control apparatus comprising:
an acquiring section configured to acquire information concerning a location and business hours of a charging stand, the charging stand configured to perform charging with a higher speed than predetermined charging;
a selecting section configured to select a first charging stand, from among a plurality of the charging stands, based on the business hours and a distance from a location of the vehicle;
a determining section configured to determine whether an amount of power needed for the vehicle to reach the first charging stand is held by the battery of the vehicle; and
a charging control section configured to, if the amount of power needed for the vehicle to reach the first charging stand is not held in the battery, perform a first charging to cause the battery to hold the power needed for the vehicle to reach the first charging stand,
wherein the charging control section is configured to perform the first charging in a manner that an amount of power held in the battery does not exceed the amount of power needed for the vehicle to reach the first charging stand by an amount greater than or equal to a predetermined value.

2. The charging control apparatus according to claim 1, wherein the first charging stand is a closest charging stand among the plurality of charging stands.

3. The charging control apparatus according to claim 1, wherein the selecting section is configured to select the first charging stand from among the plurality of charging stands further based on operating conditions thereof.

4. The charging control apparatus according to claim 1, wherein the selecting section is further configured to select a second charging stand from among the plurality of charging stands, based on the business hours and the distance from the location of the vehicle,
the determining section is further configured to determine whether an amount of power needed for the vehicle to reach the second charging stand is held in the battery, and
if the amount of power needed for the vehicle to reach the second charging stand is not held in the battery, the charging control section is further configured to perform a second charging, after the first charging, to cause the battery to hold the amount of power needed for the vehicle to reach the second charging stand.

5. The charging control apparatus according to claim 4, wherein a business end timing of the second charging stand is later than a business end timing of the first charging stand, and
the charging control section is configured to complete the second charging by a first timing that is a first predetermined time earlier than the business end timing of the first charging stand.

6. The charging control apparatus according to claim 5, wherein the charging control section is configured to start the second charging at a second timing that is a first charging time earlier than the first timing, the first charging time being a time period needed to perform the second charging.

7. The charging control apparatus according to claim 5, wherein the first predetermined time is determined based on a time period needed for the vehicle to reach the first charging stand.

8. The charging control apparatus according to claim 7, wherein the first predetermined time is determined further based on a time period needed to charge the battery at the first charging stand.

9. The charging control apparatus according to claim 4, wherein the distance from the location of the vehicle to the second charging stand is greater than the distance from the location of the vehicle to the first charging stand.

10. The charging control apparatus according to claim 4, wherein the selecting section is further configured to select a third charging stand from among the plurality of charging stands, based on the business hours and the distance from the location of the vehicle,
the determining section is further configured to determine whether an amount of power needed for the vehicle to reach the third charging stand is held in the battery, and
if the amount of power needed for the vehicle to reach the third charging stand is not held in the battery, the charging control section is further configured to perform a third charging, after the second charging, to cause the battery to hold the amount of power needed for the vehicle to reach the third charging stand.

11. The charging control apparatus according to claim 10, wherein business end timing of the third charging stand is later than the business end timing of the second charging stand, and
the charging control section is configured to complete the third charging at a third timing that is a second predetermined time earlier than the business end timing of the second charging stand.

12. The charging control apparatus according to claim 11, wherein the charging control section is configured to start the third charging at a fourth timing that is a second charging time earlier than the third timing, the second charging time being a time period needed to perform the third charging.

13. The charging control apparatus according to claim 10, wherein the distance from the location of the vehicle to the third charging stand is greater than the distance from the location of the vehicle to the second charging stand.

14. The charging control apparatus according to claim 1, further comprising a timed charging control section configured to perform timed charging of the battery,
wherein the charging by the charging control section is performed before the timed charging by the timed charging control section.

15. A charging control method comprising:
a step of selecting a first charging stand from among a plurality of charging stands configured to perform charging at a higher speed than predetermined charging, based on business hours and a distance from a location of a vehicle;
a step of determining whether an amount of power needed for the vehicle to reach the first charging stand is held by a battery of the vehicle; and
a step of, if the amount of power needed for the vehicle to reach the first charging stand is not held in the battery, performing a first charging to cause the battery to hold the power needed for the vehicle to reach the first charging stand, in a manner that an amount of power held in the battery does not exceed the amount of power needed for the vehicle to reach the first charging stand by an amount greater than or equal to a predetermined value.

16. A non-transitory computer-readable storage medium storing thereon a program that causes a computer to perform:
a step of selecting a first charging stand from among a plurality of charging stands configured to perform charging at a higher speed than predetermined charging, based on business hours and a distance from a location of a vehicle;
a step of determining whether an amount of power needed for the vehicle to reach the first charging stand is held by a battery of the vehicle; and
a step of, if the amount of power needed for the vehicle to reach the first charging stand is not held in the battery, performing a first charging to cause the battery to hold the power needed for the vehicle to reach the first charging stand, in a manner that an amount of power held in the battery does not exceed the amount of power needed for the vehicle to reach the first charging stand by an amount greater than or equal to a predetermined value.
